(19) United States
(12) Patent Application Publication
(10) Pub. No.: US 2026/0337363 A1
(43) Pub. Date: Oct. 29, 2026

(54) PROCESS FOR RECYCLING OF PLASTIC WASTE AND HIGH VALUE PRODUCTS MANUFACTURED THEREBY

(71) Applicant: CLARITER IP, Luxembourg (LU)

(72) Inventors: Daria FRACZAK, Jaworzno (PL); Justyna ODROBINSKA, Wola (PL); Antonina DRABIK, Gliwice (PL); Krzysztof BACHTA, Chorzów (PL); Marcin STEC, Gliwice (PL)

(21) Appl. No.: 19/115,638

(22) PCT Filed: Sep. 19, 2023
(86) PCT No.: PCT/IL2023/051015

§ 371 Date: Mar. 26, 2025

(30) Foreign Application Priority Data
Sep. 28, 2022 (IL) 296859

(51) Int. Cl. C08J 11/12; B29B 17/00; B29K 23/00

(52) U.S. Cl. CPC C08J 11/12; B29B 17/00; B29K 2023/06; B29K 2023/12; C08J 2323/06; C08J 2323/12

(57) ABSTRACT

The disclosure concerns processes for recycling of plastic waste by means of thermal cracking at defined conditions combined with catalytic hydrogenation treatments to obtain various high value paraffinic products with high degree of purity and reduced content of aromatic compounds. The disclosure also concerns high purity paraffinic products produced by the process, such as solvents, oils and waxes having aromatic compounds content of at most 3000 ppm.

### TECHNOLOGICAL FIELD

The present disclosure concerns a process for recycling of plastic waste by means of thermal cracking, and high value products, such as solvents, oils and waxes, manufactured thereby.

### BACKGROUND ART

References considered to be relevant as background to the presently disclosed subject matter are listed below:
WO2010/049824
WO2010/106399
WO2010/116211
WO2010/136850

Acknowledgement of the above references herein is not to be inferred as meaning that these are in any way relevant to the patentability of the presently disclosed subject matter.

### BACKGROUND

Awareness of the need of waste recycling has grown significantly in the past few decades, with the recognition that traditional disposal methods, such as landfilling or burning, have immense environmental and ecological negative impact. Of major concern are insufficient recycling processes of municipal waste. While in the European Union almost 50% of municipal waste is currently being recycled (according to Eurostat, the EU produced 502 kg of waste per capita during 2019, 48% of which have been recycled or composted), recycling rates in other first-world countries is far lower. In the US, for example, only 9% of solid municipal waste generated during 2018 was recycled. According to the United States Environmental Protection Agency, 292 million tons of municipal solid waste were produced during 2018, about 58% of which attributed to domestic paper, food and plastic waste; however only 69 million tons were recycled or composted, a major part of which (above 66%) being recycling of paper waste.

A major component in municipal and industrial waste are polyolefins, which are used for a variety of domestic products, mainly packaging, as well as for agricultural needs such as greenhouses and irrigation tubing. Since only some of the polyolefin waste is recycled into new polyolefin products, it would be beneficial to provide a recycling process that enables obtaining high valuable products from additional polyolefin plastic waste.

### General Description

The present disclosure provides an industrial recycling process of polyolefin waste for obtaining high value products, such as solvents, oils and waxes at a high degree of purity. The products produced by processes of this disclosure have low aromatic content, typically below 3000 ppm (e.g. below 2000 ppm (0.2 wt %)), and meet FDA requirements, as well as the requirements of cosmetology. In the process of this disclosure, high value byproducts are also produced, which can be used as fuel due to their high calorific value or as additives/modifiers for bituminous and asphalt masses.

Some of the unique features of the process of this disclosure are the broad range of products that can be obtained, mainly due to the broad range of intermediates produced during the thermocracking step and the ensuing hydrotreating process, which is configured for treating the thermocracking product as a whole, prior to separation into distinct hydrocarbon fractions. The process of disclosure, hence, enables obtaining a wide variety of products having a low aromatics and low impurities content from the same polyolefin feedstock in an integrated process.

According to an aspect of the present disclosure, there is provided a process for obtaining paraffinic products having an aromatic compounds content of at most about 3000 ppm from a mixture of polyolefins, the process comprising:
(a) thermocracking said mixture in a melt state in a thermolysis reactor to obtain a hydrocarbons vapor stream under conditions comprising (i) pressure of at most 1 barg, (ii) temperature ranging between about 320 °C and about 450 °C, (iii) absence of oxygen, and (iv) residence time of the mixture in the thermolysis reactor of between about 2 and about 40 hours;
(b) removing volatile C1-C5 compounds from the hydrocarbons vapor stream and quenching the remainder of the hydrocarbons vapor stream to obtain a condensate stream;
(c) transferring the condensate stream into a main catalytic hydrotreatment unit, to obtain a hydrotreated stream;
(d) separating the hydrotreated stream into product streams:
   i. a C6-C20 product stream having a boiling temperature of between about 60 °C and about 330 °C,
   ii. a C14-C32 product stream having a boiling temperature of between about 300 °C and about 450 °C, and
   iii. a C20-C70 product stream having an initial boiling temperature of at least about 350 °C; and
(e) further treating each of the product streams to obtain said paraffinic products, the paraffinic products comprising:
   i. a C6-C20 paraffinic product having an aromatic compounds content of at most about 3000 ppm,
   ii. a C14-C32 paraffinic product having an aromatic compounds content of at most about 3000 ppm, and
   iii. a C20-C70 paraffinic product having an aromatic compounds content of at most about 3000 ppm.

According to another aspect, there is provided a process for recycling polyolefins waste, comprising:
a. thermocracking a waste polyolefins mixture in a melt state in a thermolysis reactor to obtain a hydrocarbons vapor stream under conditions comprising (i) pressure of at most 1 barg, (ii) temperature ranging between about 320 °C and about 450 °C, (iii) absence of oxygen, and (iv) residence time of the mixture in the thermolysis reactor of between about 2 and about 40 hours;
b. removing volatile C1-C5 compounds from the hydrocarbons vapor stream and quenching the remainder of the hydrocarbons vapor stream to obtain a condensate stream;
c. transferring the condensate stream into a main catalytic hydrotreatment unit, to obtain a hydrotreated stream;
d. separating the hydrotreated stream into product streams:
   i. a C6-C20 product stream having a boiling temperature of between about 60 °C and about 330 °C,
   ii. a C14-C32 product stream having a boiling temperature of between about 300 °C and about 450 °C, and
   iii. a C20-C70 product stream having a boiling temperature of at least about 350 °C; and
e. further treating each of the product streams to obtain said paraffinic products, the paraffinic products comprising:
   i. a C6-C20 paraffinic product having an aromatic compounds content of at most 3000 ppm,
   ii. a C14-C32 paraffinic product having an aromatic compounds content of at most about 3000 ppm, and
   iii. a C20-C70 paraffinic product having an aromatic compounds content of at most about 3000 ppm.

According to some embodiments, the C6-C20 paraffinic product, the C14-C32 paraffinic product, and/or the C20-C70 paraffinic product have an aromatic compounds content of at most about 2000 ppm.

According to some other embodiments, each of the C6-C20 paraffinic product, the C14-C32 paraffinic product, or the C20-C70 paraffinic product has an aromatic compounds content of at most about 2000 ppm.

In the process of the present disclosure, a mixture of polyolefins is used as a feedstock. The term polyolefins (or poly(alkenes)) means to denote linear, branched, crosslinked or block polymers which consist of or are produced from olefinic monomers. The polyolefins are typically obtained from plastic waste (e.g. sorted plastic waste), with or without virgin or unprocessed polyolefins.

According to some embodiments, the mixture of polyolefins comprises polyethylene and polypropylene. By some other embodiments, the polyolefins mixture comprises polyethylene in an amount ranging between 10 wt % and 90 wt %, and polypropylene in an amount ranging between 10 wt % and 90 wt %.

By some embodiments, the polyolefins mixture consists essentially of polyethylenes. By other embodiments, the polyolefin mixture consists essentially of polypropylenes.

According to some embodiments, the polyolefins mixture comprises up-to 10 wt % of polystyrene. According to some embodiments, the polyolefins mixture comprises up-to 5 wt % of polystyrene.

According to some embodiments, the polyolefins mixture comprises up-to 5 wt % non-polyolefinic polymers other than polystyrene (e.g. polyvinylchloride, polyethylene terephthalate, acrylonitrile butadiene styrene, nylon, polyurethanes, etc.).

By some embodiments, the process comprises a pre-step before step (a), or pretreating the feedstock. For example, when the feedstock comprises plastic waste, the pretreatment of the feedstock can comprise one or more steps of separating the polyolefins from the waste, washing the waste with water, dewatering the waste, shredding the waste, and removing contaminants and/or substances of concern from the waste.

The polyolefin mixture is fed into the thermocracking reactor at step (a) in a melt state. By some embodiments, the melting of the polyolefin mixture is obtained by extrusion.

In step (a) of the process, the molten mixture is thermocracked into smaller hydrocarbon molecules. Thermocracking (or thermal cracking) means to denote decomposition of polymeric materials by means of temperature. Unlike the typical thermal process used for treating plastic waste, in the thermocracking process decomposition is carried out under inert atmospheric conditions, reducing the amount of undesired coke and promoting random scission mechanism that generates a heterogeneous mixture of paraffins, olefins and aromatics in a wide range of chain lengths.

In step (a) thermocracking is carried out under conditions of: (i) pressure of at most 1 barg, (ii) temperature ranging between about 320 °C and about 450 °C, (iii) absence of oxygen, and (iv) residence time of the mixture in the thermolysis reactor of between about 2 and about 40 hours.

In the process of this disclosure, a combination of conditions permits obtaining high yield of hydrocarbon vapor products out of the polyolefin mixture, with minimal formation of coke.

The temperature in the thermolysis reactor is maintained at a range of 320 °C-450 °C, which is lower than typical plastic waste processing processes. According to some embodiments, the temperature in the thermolysis reactor is between about 350 °C and about 420 °C. While in typical waste treatment processes higher temperatures are utilized, promoting formation of low molecular weight volatile products, the relatively low temperatures utilized in step (a) of the present process permit obtaining a wide range of condensable hydrocarbons chain lengths to enable a wide range of final products (as will be described further below). Low temperatures also minimize secondary reactions in terms of formation of aromatics, as well as degradation/cracking of wax components.

Pressure within the thermolysis reactor is maintained as to not to exceed about 1 barg, according to some embodiments not exceeding about 0.5 barg. The inventors have found that as the boiling point of the cracking products are decreased under high pressure, pressures above 1 barg will cause heavy hydrocarbons (which are desired products in the process described herein) to pyrolyze instead of vaporize at given operation temperature. Hence, under pressurized cracking, more energy is required for further hydrocarbon cracking and the average molecular weight of gas product decreases. Thus, maintaining the pressure at maximum 1 barg, preferably at most about 0.5 barg, permits obtaining energetical efficiency on the one hand and a desired profile of cracking products on the other hand.

The residence time in the thermolysis reactor is defined as the average amount of time that the mixture spends in the thermolysis reactor. The inventors have found that in the process of the present disclosure, long residence time will result in formation of light fractions and shorter residence times will produce mainly heavy fractions, a residence time of between about 2 and about 40 hours in step (a) achieves a balance of thermolysis products between light, medium and heavy fractions that can be further processed to various high value products, as will be described below. Longer residence time also reduces the amounts of olefins, enabling secondary hydrogenation of double bonds in the thermolysis reactor, ensuring lower hydrogen consumption in the hydrotreatment unit and lower exothermal effect in the hydrotreating (making the process safer and easier to control).

According to some embodiments, the residence time ranges between about 2 and about 30 hours. According to other embodiments, the residence time ranges between about 3 and about 20 hours. According to some other embodiments, the residence time ranges between about 3 and about 10 hours. According to yet other embodiments, the residence time ranges between about 4 and about 6 hours.

According to some embodiments, the process comprises treating the mixture at step (a) in one or more thermolysis reactors arranged in parallel.

By some embodiments, the thermolysis reactor can be a batch reactor, semi-batch reactor, continuous flow reactor (CFR), auger reactor or combinations thereof.

By some embodiments, where a batch, semi-batch reactor or continuous is used, the thermocracking is carried out under a flow of nitrogen or other stripping agents, like light hydrocarbon stream, for continuous removal of undesired volatiles from the reactor.

According to some embodiments, the thermolysis reactor comprises a heated circulation loop defined between a circulation outlet of the reactor and a circulation inlet of the reactor, for circulating a portion of the mixture therethrough during thermocracking. The circulation loop is designed to continuously circulate a portion of the mixture in-and-out of the thermolysis reactor. As the viscosity of the process fluid (i.e. the melt at its partially thermocracked form) in the reactor is relatively high, it is difficult to control the uniformity of temperature within the fluid. In the presently claimed process, continuous circulation of a portion of the content of the thermolysis reactor through the heated circulation loop permits better control over the temperature of the melt, while also permitting exposing small portions of the melt (i.e. the circulated portion) to a higher temperature than that maintained in the reactor for short periods of time (during passage through the loop) to enable proper heating of the mixture, while also minimizing formation of undesired coke due to the short residence time in the loop.

According to some embodiments, the temperature in the circulation loop is between about 400 °C and about 450 °C.

By some embodiments, the portion of mixture within the circulation loop during thermocracking is between about 2 and about 50% of the thermolysis reactor's volume. According to other embodiments, the portion of mixture within the circulation loop during thermocracking is between about 2 and about 30% of the thermolysis reactor's volume.

By some embodiments, step (a) further comprises removal of solid residues from the thermolysis reactor. The solids removed from the thermolysis reactor can be further treated and disposed or further utilized. For example, the solids (or as sometimes called “reactor bottoms”) can be used as fuel due to their high calorific value (typically 36-47 MJ/kg), e.g. in waste incineration plants or cement plants. The solids can also be used as cement or bitumen asphalt additives or as a binder for ores.

The thermocracking step produces a broad distribution of saturated and unsaturated hydrocarbon thermolysis products in vapor form. In step (b), volatile C1-C5 compounds are removed from the hydrocarbons vapor stream, and the remainder of hydrocarbons stream, typically comprising C6-C70 hydrocarbons, is quenched to obtain a condensate stream. The condensate stream is also referred to herein as pyrolysis oil. The non-condensable gases/vapors (C1-C5) are separated and can be utilized for energy recovery. In the processes of this disclosure, the non-condensable gases constitute about 5-15% wt of the total feed to the reactors.

By some embodiments, the temperature during quenching at step (b) of the process ranges between about 150 °C and about 250 °C.

The condensate is then treated, at step (c), as a whole in a main catalytic hydrotreatment unit to obtain a hydrotreated stream of the condensate. Hydrotreatment (or any lingual variation thereof) refers to reducing of double bonds and aromatic bonds in the hydrocarbons of the condensate stream. In addition to reducing double bonds, hydrotreating conditions applied in this process also permit fast removal of heteroatoms and non-hydrocarbon compounds by turning these into volatile compounds (for example sulfur-organic compounds as hydrogen sulfide, nitrogen containing compounds as ammonia, and oxygen-containing compounds as water). Hence, under the conditions of main hydrotreatment, concomitant processes are enabled in addition to olefin and aromatics saturation, namely removal of heteroatoms by hydro-desulphurization, denitrogenation, removal of oxygen and/or halides.

The purpose of the main hydrotreatment is to treat all hydrocarbons of the condensate stream with hydrogen (H₂). This process step also reduces the Bromine number of the treated stream to below 0.5 gBr₂/100 g. In the process of the present disclosure, hydrotreating of the complete condensate stream is essential to provide proper product quality, as well as to prevent unwanted polymerization reactions from unsaturated components further downstream of the process. Further, unlike known processes in which the condensate is first separated into fractions, and each fraction is hydrotreated separately in different systems or sequentially, one fraction after the other, in the process of this disclosure the hydrotreatment of the entire hydrocarbon condensate (without fractionation) does not necessitate flushing between fractions (as no separate fractions are treated), also preventing contamination due to treatment of different fractions in the same hydrotreater. Additionally, hydrotreatment of the entire condensate prior to separation removes resin-creating components (mainly reactive diolefins or olefins like styrene from PS), enabling to maintain long operations of the distillation columns.

According to some embodiments, the main catalytic hydrotreatment unit is operated at step (c) is carried out under conditions comprising temperature of between about 250 °C and about 340 °C, pressure of at least about 45 barg, and a hydrogen to condensate stream ratio of at least about 150 Nm³/m³ (normal cubic meter/cubic meter).

The condensate stream is heated to operating temperature of minimum 250 °C. The temperature at any time in the reactor is maintained as high as possible but not above 340 °C, as the inventors have found that, in the conditions of the process disclosed herein, aromatics' hydrogenation/saturation is not effective above 340 °C. The hydrogenation reaction of unsaturated components is exothermic, and the heat generated is primarily influenced by the composition of the feed. Higher PP concentration in the feed generates more unsaturated compounds which will be hydrogenated in this reactor. To control the temperature in the reactor and to avoid overheating (hot spots as well as run-away situations), the temperatures are controlled by H₂/HC ratio and the inlet temperature. Any heat input into the process is carefully controlled at maximum temperatures to avoid the further cracking of the hydrocarbons and the formation of coke residue. Further control of the temperature can be obtained by introduction of cold hydrogen between the catalytic beds for quenching.

By some embodiments, the difference between inlet temperature of the condensate stream and the temperature in the main catalytic hydrotreatment unit is at most 50 °C.

According to some embodiments, main hydrotreating is carried out under pressure ranging between 60 barg and 200 barg.

According to some embodiments, the feed liquid hourly space velocity (LHSV), which is a ratio of liquid feed volume flowing within an hour to the catalyst volume, ranges between 0.5 h⁻¹ and 2.0 h⁻¹. In the main hydrotreating step of the process of this disclosure, it was found that such LHSV values permit better control over the desulfurization concomitantly occurring in the hydrotreatment reactor.

The main hydrotreatment stage is a catalytic process at high temperatures and high pressures. By some embodiments, the catalytic reaction takes place on a fixed catalyst bed at the presence of a high-volume ratio of hydrogen.

By some embodiments, the catalyst in the main hydrotreatment step can be selected from alumina, silica, zeolite, noble-earth metals (cobalt, molybdenum, nickel, tungsten, platinum, zirconium and others), as well as alloys of metals.

By some other embodiments, the main catalytic hydrotreatment utilizes at least one Ni—Mo catalyst.

Catalysts are typically sensitive to poisons (for example by arsenic, vanadium, silicon, nickel but also other metals and halogenates). In the main hydrotreatment stage, the catalysts are typically prone to silicon poisoning, which may at times be present in the source material (and hence may be present to some extent in the condensate stream). To protect the catalyst in the main hydrotreatment reactor, the condensate stream can be fed into the main hydrotreatment reactor through at least one guard bed.

Thus, according to some embodiments, the condensate stream of step (b) is passed through at least one guard bed reactor comprising at least one guard bed catalyst prior to introduction into step (c).

According to some embodiments, the temperature in the at least one guard bed reactor is between about 290 °C and 340 °C. By some other embodiments, the hydrogen to condensate stream ratio in the at least one guard bed reactor is about 150 Nm³/m³.

By some embodiments, the condensate stream is passed through one or more traps to remove contaminants from the condensate stream before feeding into the main hydrotreatment reactor. The traps may be for metals, silicon, halogenates, phosphorous, etc. According to some embodiments, the one or more traps comprise iron oxide, iron exchange resin, clays, silica gel, alkaline or alkaline earth metal oxide, active aluminum oxide, active carbon, molecular sieves, high porosity nickel molybdenum (NiMo), cobalt molybdenum (CoMo) catalysts, or any combination thereof. The traps can be operated with or without hydrogen coverage.

After hydrotreatment, the hydrotreated stream is separated into product streams at step (d) of the process. The hydrotreated stream is separated into 3 main streams, typically according to the hydrocarbons molecular weight and boiling temperature: (i) a C6-C20 product stream having a boiling temperature of between about 60 °C and about 330 °C, (ii) a C14-C32 product stream having a boiling temperature of between about 300 °C and about 450 °C, and (iii) a C20-C70 product stream having an initial boiling temperature of at least about 350 °C.

By some embodiments, the main streams comprise: (i) a C6-C18 product stream having a boiling temperature of between about 100 °C and about 300 °C, (ii) a C14-C24 product stream having a boiling temperature of between about 300 °C and about 380 °C, and (iii) a C22-C70 product stream having an initial boiling temperature of at least about 380 °C.

Each of the streams (i)-(iii) is then separately treated, at step (e) to obtain the final paraffinic products.

According to some embodiments, the product streams are treated in step (e) as follows:
i. catalytically hydrotreating said C6-C20 product stream, followed by distillation in at least one solvent distillation column to obtain a C6-C20 paraffinic product having an aromatic compounds content of at most about 3000 ppm,
ii. catalytically hydrotreating said C14-C32 product stream, followed by distillation in at least one oil distillation column to obtain a C14-C32 paraffinic product having an aromatic compounds content of at most about 3000 ppm, and/or
iii. distilling said C20-C70 product stream in at least one wax distillation column to obtain a C20-C70 paraffinic product having an aromatic compounds content of at most about 3000 ppm.

In some embodiments, the C20-C70 product stream can be bleached to improve color and quality of the paraffinic product. The bleaching agent can be at least one of natural bleaching earths, acid-activated bleaching earths, activated carbon (e.g. for removal of polyaromatic hydrocarbons as well as a wide range of specific pollutants), synthetic amorphous silica (e.g. for selective removal of phosphatides, trace metals and soaps), etc.

In process step (e), the C6-C20 stream is, in some embodiments, first catalytically hydrotreated, and then distilled in at least one solvent distillation column to obtain a C6-C20 paraffinic product, typically a solvent, having an aromatic compounds content of at most about 3000 ppm, preferably at most 2000 ppm.

The catalytic hydrotreatment of the C6-C20 product stream in step (e) mainly aims at further reducing the aromatics content of the light fraction. Low boiling aromatics are especially unwanted in solvents (being the C6-C20 product) as they may present health hazards. The concentration of aromatics in the C6-C20 stream can vary directly with the presence of various contaminants (e.g. polystyrene) in the polyolefin feed mixture, and may not all be treated to the desired level in the main hydrotreating step.

The catalytic hydrotreatment of the C6-C20 product stream in step (e) is carried out under conditions comprising temperature of between about 170 °C and about 300 °C, pressure of at least 45 barg, and hydrogen to condensate stream ratio of at least 150 Nm³/m³ (normal cubic meter/cubic meter). These conditions are not only aiming at significant conversion of aromatics, but also at avoiding overheating, which may cause undesired side reactions.

By some embodiments, the C6-C20 product stream is treated by one or more distillation stages in order to obtain a C6-C20 paraffinic product with an aromatic compounds content of at most about 3000 ppm, preferably at most 2000 ppm. The C6-C20 paraffinic products are typically solvents having a boiling temperature of between about 100 °C and about 360 °C. Various solvents, having different boiling temperature ranges within this broad range, can be obtained by varying the parameters of the distillation column and/or by utilizing two or more consecutively arranged solvent distillation columns.

The C14-C32 product stream is catalytically hydrotreating at step (e), followed by distillation in at least one oil distillation column to obtain a C14-C32 paraffinic product having an aromatic compounds content of at most about 3000 ppm, preferably at most 2000 ppm. The purpose of hydrotreating the C14-C32 product stream is mainly to isomerize linear paraffins of this hydrocarbons fraction into branched paraffins, in order to obtain an oil product with an improved cloud point of below-10 °C and the pour point of the oil of below-20 °C. The cloud point and pour point are an indication of linear waxes present in the oil, which are unwanted in oil products. Another purpose of the hydrotreatment of the C14-C32 product stream is to mildly hydrocrack long chain hydrocarbons into shorter-chain hydrocarbons, effectively dewaxing the C14-C32 product.

According to some embodiments, catalytically hydrotreating said C14-C32 product stream in step (e) comprising hydrotreating the C14-C32 product stream under conditions comprising a temperature of between about 310 °C and about 360 °C, pressure of at least 25 barg, and a hydrogen to C14-C32 product stream ratio of at least 150 Nm³/m³.

According to some other embodiments, catalytically hydrotreating said C14-C32 product stream in step (e) is carried out in two consecutive hydrotreatment steps:
step (e1) comprising hydrotreating the C14-C32 product stream under conditions comprising a temperature of between about 310 °C and about 360 °C, pressure of at least 30 barg, and a hydrogen to C14-C32 product stream ratio of at least 150 Nm³/m³; followed by:
step (e2) comprising hydrotreating the product of step (e1) under conditions comprising a temperature of between about 170 °C and about 300 °C, pressure of at least 25 barg, and a hydrogen to C14-C32 product stream ratio of at least 150 Nm³/m³.

In step (e1), the C14-C32 product stream is isomerized, while in step (e2), the isomerized stream is further treated to convert the remainder of unsaturated hydrocarbons into saturated hydrocarbons, thereby further reducing aromatics content in the resulting oil product. Step (e2) also improves the color of the oil according to the Saybolt color scale.

According to some embodiments, the process comprises dewaxing (mild hydrocracking) the C14-C32 product stream, for removal of hydrocarbons which readily solidify (i.e. waxes). Removal of wax is typically required for the production of lubricating oil which will remain fluid over a broad range of temperatures. The catalytic dewaxing process comprises passing the C14-C32 product stream through a catalyst in which the active hydrocracking sites are accessible only to the paraffin molecules, and selectively hydrocracks waxy molecules to short-chain products, leaving valuable lube oil components unchanged.

By some embodiments, the C14-C32 product stream is treated by one or more distillation stages in order to obtain a C14-C32 paraffinic product with an aromatic compounds content of at most 2000 ppm. The C14-C32 paraffinic products are typically oils, that comprise at least 50 wt % C14-C32 iso-paraffinic compounds, preferably at least about 95 wt % C14-C32 iso-paraffinic compounds and have kinematic viscosity ranging between 5.00 mm²/s and 15.00 mm²/s, as measured according to ISO 3104 at 40 °C. The oils obtained after distillation typically have a boiling temperature of between about 320 °C and about 420 °C.

In the process of this disclosure C20-C70 product stream is distilled at step (e) in a wax distillation column to obtain the C20-C70 paraffinic product.

According to some embodiments, the C20-C70 paraffinic product is a wax, typically comprising at least 95 wt % C20-C70 normal paraffinic compounds (determined by GC/MS), with an oil content of between about 10 wt % and 60 wt %, and no more than about 3000 ppm aromatic compounds. The waxes obtained after distillation typically have a boiling temperature of at least 350 °C.

According to other embodiments, the C20-C70 paraffinic product comprises up to about 85 wt % iso-paraffins and up to about 60 wt % of n-paraffins (determined according to ASTM D5442), and no more than about 3000 ppm aromatic compounds.

Wax distillation can be carried out by one or more distillation steps. According to some embodiments, the distillation products of each distillation step are blended at pre-determined ratios to obtain the wax product.

As noted, the paraffinic products produced by the process of this disclosure are characterized by low aromatics content, i.e. below about 3000 ppm, preferably below 2000 ppm. The paraffinic products are also characterized by low sulfur content (typically below 10 ppm), low nitrogen content, low chlorine content, controlled paraffins ratios, etc.

According to some embodiments, the paraffinic products produced by the process of this disclosure meet the FDA requirements for amount of Polycyclic Aromatic Hydrocarbons (PAHs).

According to some embodiments, the oil and solvent products meet the requirements of U.S. FDA qualitative test, 21CRF § 178.3620 within the range of the limits in the ultraviolet absorbance at specific wavelengths: 280-289 nm A<4.0, 290-299 nm A<3.3, 300-329 nm A<2.3, 330-360 nm A<0.8 (test method ASTM D2269-99). According to some embodiments, the wax products meet the requirements of FDA 21 CRF § 172.886, for maximum ultraviolet absorbance limits for a specific path length: 280-289 nm A<0.15, 290-299 nm A<0.12, 300-359 nm A<0.08, 360-400 nm A<0.02.

Hence, by another aspect of this disclosure, there is provided a paraffinic solvent having a boiling range of at most about 100 °C, an initial boiling point of at least about 85 °C, and final boiling point of in the range of between about 150 °C and about 360 °C, the fluid comprises normal paraffinic compounds in the range of between about 15 wt % and 65 wt %, isoparaffinic compounds in the range of between about 30 wt % and about 75 wt %, cyclo-paraffinic compounds in the range of between about 0 wt % and about 35 wt %, and no more than about 3000 ppm of aromatic compounds.

By some embodiments, the paraffinic solvent comprises no more than about 2000 ppm of aromatic compounds.

By some embodiments, the paraffinic solvent is obtained by the process described herein.

By some embodiments, the paraffinic solvent comprises C6-C20 paraffinic hydrocarbons. According to other embodiments, the paraffinic solvent consists essentially of paraffinic C6-C20 hydrocarbons.

According to some embodiments, the percent ratio between the n-paraffins and iso-paraffins (i.e. percent n-paraffins to percent iso-paraffins) in the C6-C20 paraffinic product ranges between about 1:1.2 and about 1:2.5.

According to other embodiments, the percent ratio between the n-paraffins and iso-paraffins in the C6-C20 paraffinic product ranges between about 1:1.5 and about 1:4.5.

According to some other embodiments, the percent ratio between the n-paraffins and iso-paraffins in the C6-C20 paraffinic product ranges between about 1:1.2 and about 1:4.5.

By some embodiments, the paraffinic solvent comprises less than 3 ppm of each of sulfur, chloride and nitrogen.

According to some embodiments, the paraffinic solvent has an initial boiling point ranging between about 85 °C and about 110 °C, final boiling point of in the range of between 155 °C and 180 °C, and kinematic viscosity ranging between 0.70 mm²/s and 0.90 mm²/s (as measured according to ASTM D445 at 25 °C).

According to other embodiments, the paraffinic solvent has an initial boiling point ranging between about 135 °C and about 160 °C, final boiling point of in the range of between 185 °C and 220 °C, and kinematic viscosity ranging between 1.00 mm²/s and 1.40 mm²/s (as measured according to ASTM D445 at 25 °C).

According to some other embodiments, the paraffinic solvent has an initial boiling point ranging between about 170 °C and about 195 °C, final boiling point of in the range of between 235 °C and 250 °C, and kinematic viscosity ranging between 1.60 mm²/s and 1.90 mm²/s (as measured according to ASTM D445 at 25 °C).

According to some other embodiments, the paraffinic solvent has an initial boiling point ranging between about 190 °C and about 210 °C, final boiling point of in the range of between 245 °C and 270 °C, and kinematic viscosity ranging between 1.80 mm²/s and 2.40 mm²/s (as measured according to ASTM D445 at 25 °C).

According to yet other embodiments, the paraffinic solvent has an initial boiling point ranging between about 205 °C and about 245 °C, final boiling point of in the range of between 270 °C and 290 °C, and kinematic viscosity ranging between 1.95 mm²/s and 3.10 mm²/s (as measured according to ASTM D445 at 25 °C).

According to further embodiments, the paraffinic solvent has an initial boiling point ranging between about 240 °C and about 280 °C, final boiling point of in the range of between 335 °C and 360 °C, and kinematic viscosity ranging between 5.50 mm²/s and 7.20 mm²/s (as measured according to ASTM D445 at 25 °C).

According to some other embodiments, the paraffinic solvent has an initial boiling point ranging between about 240 °C and about 260 °C, final boiling point of in the range of between 310 °C and 330 °C, and kinematic viscosity ranging between 3.30 mm²/s and 4.70 mm²/s (as measured according to ASTM D445 at 25 °C).

By another aspect, there is provided a paraffinic solvent as disclosed herein for use in cosmetic products, paints, printing ink, plasticizers, degreasers, textile manufacturing, explosive manufacturing, cleaning products manufacturing, self-starting barbecue brickettes, solvent extraction (copper and others), road solvents, and wood preservatives (resins for timber and foundry applications). By another aspect, there is provided a paraffinic solvent as disclosed herein for use as solvent in surfactant production or as in pesticides compositions.

According to another aspect, there is provided an article of manufacture comprising at least one paraffinic solvent as disclosed herein, said article of manufacture being selected from a cosmetic product, a paint, a plasticizer, a degreaser, a cleaning product, an explosive product, a printing ink, a self-starting barbecue brickette, an extraction/leaching solution, a road solvent, wood preservatives, and pesticide compositions.

By another aspect, there is provided a paraffinic oil comprising at least 50 wt % C14-C32 iso-paraffinic compounds, preferably at least 95 wt % C14-C32 iso-paraffinic compounds and having kinematic viscosity ranging between 5.00 mm²/s and 15.00 mm²/s, as measured according to ASTM D445 at 25 °C, the fluid comprising no more than about 3000 ppm of aromatic compounds.

By some embodiments, the paraffinic oil comprises no more than about 2000 ppm of aromatic compounds.

By some embodiments, the paraffinic oil is obtained by the process described herein.

According to some embodiments, the paraffinic oil has an initial boiling point of at least about 300 °C, and final boiling point of at least about 380 °C.

By some embodiments, the paraffinic oil has a boiling temperature of between about 300 °C and about 380 °C.

By some embodiments, the paraffinic oil has a boiling temperature of between about 320 °C and about 420 °C.

According to another aspect, there is provided a paraffinic oil as disclosed herein, for use in food processing, cosmetics, pharmaceutical formulations, energy storage devices, agricultural products, as base oils, metal working fluid, and biodiesel substitute.

According to another aspect, there is provided an article of manufacture comprising at least one paraffinic oil as disclosed herein, the article of manufacture being selected from a food processing product, a cosmetic product, a pharmaceutical product, an energy storage device, an agricultural product, a base oil, a metal working fluid, and biodiesel substitute.

By yet a further aspect, there is provided a paraffinic wax comprising at least 95 wt % C20-C70 normal paraffinic compounds (determined by GC/MS), an oil content of between about 10 wt % and 60 wt %, and no more than about 3000 ppm aromatic compounds.

By a further aspect, there is provided a paraffinic wax comprising at least 85 wt % C20-C70 paraffinic compounds, said C20-C70 paraffinic compounds comprising up to about 85 wt % C20-C70 iso-paraffins and up to about 60 wt % of C20-C70 n-paraffins (determined according to ASTM D5442), and no more than 3000 ppm aromatic compounds.

By some embodiments, the paraffinic wax comprises no more than about 2000 ppm of aromatic compounds.

According to some embodiments, the paraffinic wax has a needle penetration (at 25 °C, ASTM D1321) of at least 100, congealing point of 40-60 °C (ASTM D938), and kinematic viscosity of 3-5.5 mm²/s (at 100 °C, ISO 3104).

According to some other embodiments, the paraffinic wax has a needle penetration (at 25 °C, ASTM D1321) of 70-105, congealing point of 50-65 °C (ASTM D938), and kinematic viscosity of 4.5-7.5 mm²/s (at 100 °C, ISO 3104).

According to other embodiments, the paraffinic wax has a needle penetration (at 25 °C, ASTM D1321) of 60-95, congealing point of 60-80 °C (ASTM D938), and kinematic viscosity of 7.5-10 mm²/s (at 100 °C, ISO 3104).

According to further embodiments, the paraffinic wax has a needle penetration (at 25 °C, ASTM D1321) of 70-155, congealing point of 50-70 °C (ASTM D938), and kinematic viscosity of 4.5-8.0 mm²/s (at 100 °C, ISO 3104).

According to yet other embodiments, the paraffinic wax has a needle penetration (at 25 °C, ASTM D1321) of 60-120, congealing point of 55-80 °C (ASTM D938), and kinematic viscosity of 7-10 mm²/s (at 100 °C, ISO 3104).

By some embodiments, the paraffinic wax is obtained by the process disclosed herein.

An important parameter for producers of wax is the low content of polycyclic aromatic hydrocarbons (PAHs), many of which are toxic, carcinogenic and mutagenic substances.

By another aspect there is provided a paraffinic wax as disclosed herein, for use in shoe polish, floor polish, candles, tissue-paper softening, manufacture of wax paper and paper packages, matches, pesticide traps, tire manufacturing, anti-ozonate formulations, lubricating aids, fertilizers, anti-caking aids, agricultural products, fruit and/or vegetable coating, hydrophobic coatings, concrete curing, cosmetics, hot melt adhesives (for food), mining, road applications (road resins markings, bitumen extender), fatty acids derivatives, PVC stabilizers, and wax emulsions.

According to another aspect, there is provided an article of manufacture comprising a paraffinic wax as disclosed herein, the article of manufacture being selected from a shoe polish, a floor polish, a candle, a tissue-paper softening formulation, wax paper, waxed paper packages, matches, a pesticide trap, a tire, an anti-ozonate formulation, a lubricating aid, a fertilizer, an anti-caking aid, an agricultural product, a fruit and/or vegetable coating, a hydrophobic coating, a concrete curing agent, a cosmetic product, a hot melt adhesive, a PVC stabilizer and a wax emulsion.

As noted, the residues, solids or reactor bottoms that are separated from the thermolysis reactor during thermocracking can be used as a stand-alone product. Thus, by another aspect of this disclosure, there is provided a solid product obtained by a process of this disclosure, and comprising thermocracking residue having a total solids, namely coke/carbon and ash content of at least 30 wt %, and a calorific value of at least 30 MJ/kg.

According to some embodiments, the solid product comprises at most 0.5 wt % sulfur, at most 0.5 wt % nitrogen, at most 0.3 wt % chlorine, and/or at most 0.01 ppm mercury.

According to some other embodiments, the solid product comprises between about 5 and 15 wt % hydrogen.

According to other embodiments, the solid product comprises between about 30 and 95 wt % volatile components.

According to another aspect of the present disclosure, there is provided a manufacturing facility for processing polyolefin waste into paraffinic products having an aromatic compounds content of at most 2000 ppm, the facility comprising:
a. a thermolysis reactor for receiving a mixture of polyolefins in a melt state, and thermocracking said mixture to obtain a hydrocarbons vapor stream, the thermolysis reactor being configured for operation under conditions comprising (i) pressure of at most 1 barg, (ii) temperature ranging between about 320 °C and about 450 °C, (iii) absence of oxygen, and (iv) residence time of the mixture in the thermolysis reactor of between about 2 and about 40 hours;
b. a quenching column in fluid communication with said thermolysis reactor and configured for receiving the hydrocarbons vapor stream, removing volatile C1-C5 volatile compounds therefrom, quenching the remainder of the hydrocarbons vapor stream to obtain a condensate stream;
c. a main catalytic hydrotreatment unit, in fluid communication with said quenching column, and configured for hydrotreating the condensate stream to obtain a hydrotreated stream;
d. a pressurized separation column, in fluid communication with said main catalytic hydrotreatment unit, and configured to separate the hydrotreated stream into product streams:
   i. a C6-C20 product stream having a boiling temperature of between about 60 °C and about 330 °C,
   ii. a C14-C32 product stream having a boiling temperature of between about 300 °C and about 450 °C, and
   iii. a C20-C70 product stream having a boiling temperature of at least about 350 °C; and
e. one or more treating units, in fluid communication with said pressurized separation column, said one or more treating unit being each configured to receive one of the product streams and treat the product stream therein to obtain said paraffinic products.

According to some embodiments, the one or more treating units of the facility comprise at least one catalytic hydrotreating unit, for hydrotreating said C6-C20 product stream, and at least one solvent distillation column for distilling the C6-C20 product stream after hydrotreating to obtain a C6-C20 paraffinic product having an aromatic compounds content of at most about 3000 ppm, preferably at most about 2000 ppm.

According to some embodiments, the one or more treating units of the facility comprise at least one catalytic hydrotreating unit for hydrotreating said C14-C32 product stream, and at least one oil distillation column for distilling the C14-C32 product stream after hydrotreating to obtain a C14-C32 paraffinic product having an aromatic compounds content of at most 3000 ppm.

According to some embodiments, the facility comprises a catalytic hydrotreating unit for treating said C14-C32 product stream under conditions comprising a temperature of between about 320 °C and about 360 °C, pressure of at least 25 barg, and a hydrogen to C14-C32 product stream ratio of at least 150 Nm³/m³.

According to some other embodiments, the facility comprises two catalytic hydrotreating units, arranged in sequence, for treating said C14-C32 product stream: a first catalytic hydrotreating unit for hydrotreating the C14-C32 product stream under conditions comprising a temperature of between about 310 °C and about 360 °C, pressure of at least 25 barg, and a hydrogen to C14-C32 product stream ratio of at least 150 Nm³/m³; followed by a second catalytic hydrotreating unit for hydrotreating the product received from the first catalytic hydrotreating unit under conditions comprising a temperature of between about 170 °C and about 300 °C, pressure of at least 25 barg, and a hydrogen to C14-C32 product stream ratio of at least 150 Nm³/m³.

According to some embodiments, the one or more treating units of the facility comprise at least one wax distillation column for distilling said C20-C70 product stream to obtain a C20-C70 paraffinic product having an aromatic compounds content of at most 3000 ppm.

According to some embodiments, the facility further comprises at least one extruder for obtaining said melt of polyolefins before introduction into the thermolysis reactor.

According to some embodiments, the thermolysis reactor comprises a heated circulation loop defined between a circulation outlet of the reactor and a circulation inlet of the reactor, for circulating a portion of the mixture therethrough during thermocracking.

By some embodiments, the facility further comprises at least one guard bed reactor comprising at least one guard bed catalyst, located between the quenching column and the main hydro treatment unit, and configured for receiving condensate stream from the quenching column and treating the condensate stream therein to remove contaminants therefrom prior to hydrotreating.

By some embodiments, the facility comprises at least one contaminants' trap, located between the quenching column and the main hydro treatment unit, and configured for receiving condensate stream from the quenching column and removing one or more contaminants from the condensate stream prior to hydrotreating.

As used herein, the term about is meant to encompass deviation of +10% from the specifically mentioned value of a parameter, such as temperature, pressure, concentration, etc.

Whenever a numerical range is indicated herein, it is meant to include any cited numeral (fractional or integral) within the indicated range. The phrases ranging/ranges between a first indicate number and a second indicate number and “ranging/ranges from” a first indicate number “to” a second indicate number are used herein interchangeably and are meant to include the first and second indicated numbers and all the fractional and integral numerals therebetween.

The phrase consists essentially of means to denote a composition or mixture which comprises at least 98 wt % of a single component.

Ppm means to denote parts per million.

Throughout this specification and the claims which follow, unless the context requires otherwise, the word comprise, and variations such as comprises and comprising, will be understood to imply the inclusion of a stated integer or step or group of integers or steps but not the exclusion of any integer or step or group of integers and steps.

Generally, it is noted that the term . . . at least one . . . as applied to any component of the product or process should be read to encompass one, two, three, four, five, or even more different occurrences of said component in a product or process disclosed herein.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

The processes of the present disclosure involve numerous process steps which may or may not be associated with other common physical-chemical processes so as to achieve the desired purity and form of each product. Unless otherwise indicated, such process steps, if present, may be set in different sequences without affecting the workability of the process and its efficacy in achieving the desired end result. As a person skilled in the art would appreciate, a sequence of steps may be employed and changed depending on various economical aspects, material availability, raw materials, environmental considerations, etc.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a schematic representation of an exemplary process and facility according to an embodiment of this disclosure.

### DETAILED DESCRIPTION OF EMBODIMENTS

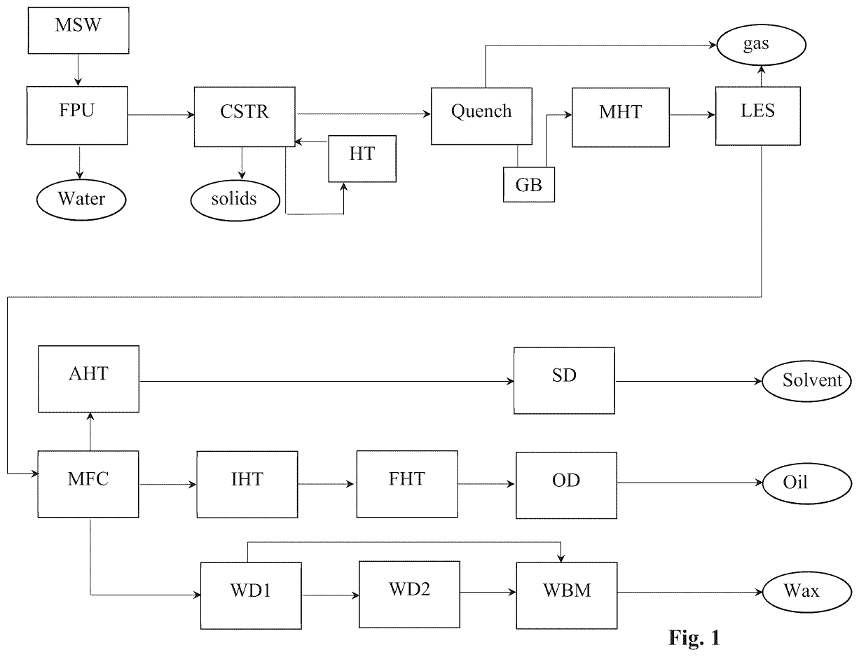

Shown in FIG. 1 is an exemplary process and facility for carrying out the process according to an embodiment of this disclosure. In FIG. 1, the following acronyms are utilized:
MSW—Mixed Solid Waste Preparation Unit
FPU—Feed Preparation Unit
CSTR—Thermocracking reactor
FL—Filter
HT—Heater
GB—Guard Bead
MHT—Main Hydrotreater
LES—Light Ends Stabilizer column
MFC—Main Fractionation Column
AHT—Aromatics Hydrotreater
IHT—Isomerization Hydrotreater
FHT—Finishing Hydrotreater
SD—Solvent Distillation
OD—Oil Distillation
WD—Waxes Distillation
WBM—Waxes Blending Mixer

Turning to FIG. 1, shown is an exemplary process and facility for carrying out the process according to this disclosure. The process shown in FIG. 1 is first fed with a feedstock comprising, and at times consisting of, a polyolefin mixture. The Mixture is prepared in the Mixed Solid Waste (MSW) Preparation Unit, and transferred into the Feed Preparation Unit (FPU), which typically comprises at least one dryer and one extruder for drying, blending and melting the polyolefins feedstock.

The melt mixture is fed into the thermocracking reactor (CSTR), in which thermocracking of the mixture takes place, decomposing the long polyolefin chains into shorter hydrocarbon molecules. Solids are continuously removed from the CSTR, while a portion of the mixture is circulated through a forced circulation loop. In the circulation loop, the portion of the mixture is circulated back into the CSTR via a heater (HT). Such circulation facilitates better control over the overall temperature of the mixture, and enables heating portions of the mixture that are circulated through the loop to a higher temperature than that of the CSTR. As the viscosity of the melt in the reactor is relatively high, it is difficult to control uniformity of temperature within the melt; continuous circulation of a portion of the content of the thermolysis reactor through the heated circulation loop permits better control over the temperature of the melt and better control of the residence time, while also permitting exposing small portions of the melt (i.e. the circulated portion) to a higher temperature than that maintained in the reactor for short periods of time (during passage through the loop) to enable proper heating of the mixture, while also minimizing formation of undesired coke due to the short residence time in the loop.

Thermocracking is carried out under conditions comprising (i) pressure of at most 1 barg, preferably at most 0.5 barg (ii) temperature ranging between about 320 °C and about 450 °C, preferably between about 350 °C and 420 °C (iii) absence of oxygen, and (iv) residence time of the mixture in the thermolysis reactor of between 2 and 40 hours, preferably between about 4 and about 6 hours. Such conditions are optimal in the process of this disclosure for obtaining a broad range of hydrocarbon fractions, which are utilized in the process to produce a wide range of final products from a single thermocracking step. In addition, such conditions are designed to maximize the formation of heavy products (e.g. wax products), as well as to minimize the formation of coke.

The thermolysis products exit the CSTR as a hydrocarbons vapor stream, and are quenched in a quenching column. In the quenching column, condensable gaseous hydrocarbons (C6<) are condensed into a condensate stream, while the lighter products (C1-C5) are vented out as gas, to be collected and further utilized as an energy source or as a gas product.

The condensate stream is then transferred into the Main Hydrotreatment Unit (MHT), in which catalytic hydrotreating takes place for reducing the content of aromatic and olefinic hydrocarbons in the stream by hydrogenating the multiple bonds in non-saturated hydrocarbons. In addition to reducing multiple bonds, the hydrotreating conditions applied in this process also permit fast removal of heteroatoms and non-hydrocarbon compounds by turning these into volatile compounds (for example sulfur-organic compounds as hydrogen sulfide, nitrogen containing compounds as ammonia, and oxygen-containing compounds as water).

Importantly, and contrary to known processes, in the processes of this disclosure the entire condensate stream is hydrotreated, without fractionation. Such hydrotreatment of the entire range of thermocracking products enables to obtain a broad range of hydrocarbons in a single hydrotreatment step, together with efficient reduction in olefins and aromatics content. This enables obtaining a broad range of products with careful control over the aromatics content from a uniform and integral manufacturing process.

Typically, the MHT in a process according to this disclosure is operated under conditions comprising temperature of between about 250 °C and about 340 °C, pressure of at least 45 barg, and a hydrogen to condensate stream ratio of at least 150 Nm³/m³ (normal cubic meter/cubic meter). Such conditions were found to maximize hydrotreatment efficiency, while also preventing undesired polymerization of the hydrocarbons in the MHT.

As the MHT catalysts can be sensitive to poisoning, most particularly silicon poisoning, the condensate stream can be fed into the MHT via at least one Guard Bed (GB), which typically comprises at least one guard bed catalyst for removing undesired contaminants. Further (or alternatively), the condensate stream can be passed through one or more traps (not shown) for removing contaminants from the condensate stream before feeding into the MHT, for example removing metals, silicon, halogenates, phosphorous, etc. from the stream.

The hydrotreated stream can be treated in a Light Ends Stabilizer column (LES) for removing further C1-C5 gaseous hydrotreatment products that may be contained in the hydrotreated stream, and from there the C6<hydrotreated stream is fed into a Main Fractionation Column (MFC) for separation into fractions, typically based on boiling temperature and molecular weight. The MFC, which can be for example a tray or packed type column, is typically operated under atmospheric pressure and heated to about 330 °C. Three main product streams are obtained from the MFC: (i) a C6-C20 product stream having a boiling temperature of between about 60 °C and about 330 °C, (ii) a C14-C32 product stream having a boiling temperature of between about 300 °C and about 450 °C, and (iii) a C20-C70 product stream having a boiling temperature of at least about 350 °C.

Each of these product streams is then treated in one or more treatment steps in order to obtain the final paraffinic products.

The C6-C20 stream is first catalytically hydrotreated in the Aromatics Hydrotreatment unit (AHT) to further reduce the aromatics content of the light fraction. Low boiling aromatics are especially unwanted in solvents as they may present health hazards. The stream is then distilled in at least one Solvent Distillation column (SD) to obtain a C6-C20 paraffinic product, i.e. the solvent, that has an aromatic compounds content of at most 3000 ppm, preferably at most 2000 ppm. The catalytic hydrotreatment in the AHT can be carried out under conditions comprising a temperature of between about 170 °C and about 300 °C, pressure of at least 45 barg, and hydrogen to condensate stream ratio of at least 150 Nm³/m³ (normal cubic meter/cubic meter). These conditions do not only aim at significant conversion of aromatics, but also at avoiding overheating, which may cause undesired side reactions.

The SD can contain a plurality of distillation stages carried out in sequence, out of each stage a different solvent fraction can be isolated as a separate solvent product depending on its boiling temperatures. Thus, various solvents having different boiling temperature ranges can be obtained by varying the parameters of the distillation column and/or by utilizing two or more solvent distillation columns consecutively arranged.

The C14-C32 product stream is also catalytically hydrotreated. In the exemplified process, the C14-C32 product stream is first catalytically hydrotreated in an Isomerization Hydrotreating Unit (IHT), then in a Finishing Hydrotreatment Unit (FHT), and then distilled in one or more Oil Distillation columns (OD), to obtain a C14-C32 paraffinic oil product having an aromatic compounds content of at most 3000 ppm, preferably at most 2000 ppm. According to some embodiments, the C14-C32 is an isoparaffinic oil. The purpose of the IHT is mainly to isomerize linear paraffins of this hydrocarbons fraction into branched paraffins in order to obtain an oil product with an improved cloud point of below-10 °C and the pour point of the oil of below-20 °C, while the purpose of the FHT is to convert the remainder of unsaturated hydrocarbons into saturated hydrocarbons, thereby further reducing the aromatics content in the resulting oil product.

IHT can be carried out under conditions comprising a temperature of between about 310 °C and about 360 °C, pressure of at least 25 barg, and a hydrogen to C14-C32 product stream ratio of at least 150 Nm³/m³. FHT is typically carried out under conditions comprising a temperature of between about 170 °C and about 300 °C, pressure of at least 25 barg, and a hydrogen to C14-C32 product stream ratio of at least 150 Nm³/m³.

After distillation in the OD, a C14-C32 paraffinic oil product is obtained with an aromatic compounds content of at most 2000 ppm, that comprise at least 50 wt % C14-C32 iso-paraffinic compounds, preferably at least 95 wt % C18-C27 iso-paraffinic compounds and kinematic viscosity ranging between 5.00 mm²/s and 15.00 mm²/s, as measured according to ASTM D445 at 25 °C. The oils obtained after distillation typically have a boiling temperature of between about 300 °C and about 380 °C.

The C20-C70 product stream is distilled in one or more Wax Distillation columns (WD). In this specific example, two wax distillation columns are utilized, WD1 and WD2 arranged in a series. The resulting wax product from WD1 and WD2 can be stand-alone wax products, however these can also be mixed in a Waxes Blending Mixer (WMB) to obtain the paraffinic wax product.

Tables 1-1 and 1-2 below show the composition of the various streams during a process according to this disclosure, starting from different waste polyolefins feedstock.

TABLE 1-1
group compositions during process (wt %), feedstock of PE/PP 70:30, 5% PS

| | Condensate | Hydrotreated | C6-C20 stream | | C14-C32 stream | |
|---|---|---|---|---|---|---|
| composition | stream | stream | before AHT | After AHT | Before IHT | After FHT |
| n-paraffins | 35-45 | 50-60 | 34-44 | 30-44 | 75-85 | 0-8 |
| olefins | 10-20 | 0 | 0 | 0 | 0 | 0 |
| iso-olefins | 28-38 | 0 | 0 | 0 | 0 | 0 |
| iso-paraffins | 0-10 | 32-42 | 49-59 | 51-61 | 16-26 | 92-99 |
| cyclo-paraffins | 0-5 | 0-5 | 0-5 | 2-13 | 0 | 0 |
| aromatics | 0-10 | 0-10 | 0-10 | 0 | 0 | 0 |

TABLE 1-2
group compositions during process (wt %), feedstock of PE/PP 30:70, 5% PS

| | | | C6-C20 stream | | | |
|---|---|---|---|---|---|---|
| | Condensate | Hydrotreated | before | | C14-C32 stream | |
| composition | stream | stream | AHT | After AHT | Before IHT | After FHT |
| n-paraffins | 10-14 | 16-20 | 13-17 | 14-18 | 20-28 | 2-6 |
| olefins | 4-8 | 0 | 0 | 0 | 0 | 0 |
| iso-olefins | 63-67 | 0 | 0 | 0 | 0 | 0 |
| iso-paraffins | 7-11 | 72-76 | 74-78 | 74-78 | 71-81 | 91-99 |
| cyclo-paraffins | 1-5 | 1-5 | 2-6 | 6-10 | 0 | 0 |
| aromatics | 3-7 | 3-7 | 3-7 | 0 | 0 | 0 |

Exemplary Products Obtained by Processes of this Disclosure

Tables 2-1 and 2-2 provide analytical data for various paraffinic solvents obtained by a process of this disclosure, from different waste polyolefin feedstocks. Tables 2-3 to 2-5 show the chemical composition of various solvent fractions obtained for different feedstocks. Table 2-4 provides additional paraffinic solvent products obtained by a process according to another embodiment of this disclosure.

TABLE 2-1
analytical results for paraffinic solvents, feedstock PE/PP

| Parameter | Method | Solvent 1 | Solvent 2 | Solvent 3 | Solvent 4 | Solvent 5 |
|---|---|---|---|---|---|---|
| Distillation range | | | | | | |
| [°C]: | | | | | | |
| Initial BP* | ISO 3405 | 97-107 | 142-151 | 185-191 | 228-240 | 255-275 |
| 90% | | 142-148 | 182-185 | 227-232 | 268-272 | 323-328 |
| Final BP | | 170-180 | 190-205 | 240-245 | 280-285 | 340-345 |
| Flash point [°C] | ASTM D93 | <10 | >35 | >60 | >90 | >110 |
| Density (@15 °C) | ISO 3838 | 724-734 | 750-760 | 772-778 | 785-791 | 795-805 |
| [kg/m³] | | | | | | |
| Density (@20 °C) | ISO 3838 | 720-729 | 745-755 | 769-774 | 783-789 | 795-805 |
| [kg/m³] | | | | | | |
| Kinematic | ASTM D445 | 0.765-0.795 | 1.05-1.15 | 1.70-1.85 | 2.85-3.05 | 5.55-6.10 |
| viscosity | | | | | | |
| (@25 °C) [cSt] | | | | | | |
| Kinematic | ASTM D445 | 0.670-0.700 | 0.89-0.93 | 1.30-1.45 | 2.10-2.33 | 3.80-4.30 |
| viscosity | | | | | | |
| (@40 °C) [cSt] | | | | | | |
| Bromine number | ASTM | <2.0 | <0.5 | <1 | <1 | <1 |
| [g/100 g] | D1159 | | | | | |
| Aniline point [°C] | ASTMD611 | 67-72 | 70-76 | 78-85 | 85-90 | 95-99 |
| Aromatic content | GC/MS | <2000 | <2000 | <2000 | <2000 | <2000 |
| [ppm] | | | | | | |
| Color (Saybolt) | ASTMD156 | +30 | +30 | +30 | +30 | +30 |
| Sulfur content | ISO 20846 | <1 | <1 | <1 | <1 | <1 |
| [mg/kg] | | | | | | |
| Chloride content | PN EN 14077 | <1 | <1 | <1 | <1 | <1 |
| [mg/kg] | | | | | | |
| Nitrogen content | ASTM | <1 | <1 | <1 | <1 | <1 |
| [mg/kg] | D4629 | | | | | |
| Vapor pressure | PN EN | 6.0-8.5 | 0.5-3.0 | <1 | <0.1 | <0.1 |
| (37.8 °C) | 13016-1 | | | | | |
| [kPa] | | | | | | |
| Refractive index | PN81/ | 1.267-1.549 | 1.278-1.562 | 1.288-1.574 | 1.294-1.582 | 1.301-1.591 |
| | C04952 | | | | | |
| Composition: | | | | | | |
| n-paraffins | GC/MS | 18-22 | 24-28 | 33-37 | 37-41 | 57-61 |
| iso-paraffins | | 60-64 | 62-66 | 60-64 | 59-63 | 39-43 |
| cyclo-paraffins | | 16-20 | 8-12 | 1-5 | 0-5 | 0-3 |

*BP—Boiling point

TABLE 2-2
analytical results for paraffinic solvents, feedstock PE/PP, 5% PS

| Parameter | Method | Solvent 6 | Solvent 7 | Solvent 8 | Solvent 9 | Solvent 10 |
|---|---|---|---|---|---|---|
| Distillation range | | | | | | |
| [°C]: | | | | | | |
| Initial BP* | ISO 3405 | 88-107 | 138-151 | 173-191 | 210-240 | 245-275 |
| 90% | | 141-148 | 141-148 | 226-230 | 265-272 | 327-334 |
| Final BP | | 158-176 | 190-198 | 239-245 | 275-285 | 337-355 |
| Flash point [°C] | ASTM D93 | <10 | >30 | >51 | >82 | >110 |
| Density (@ 15 °C) | ISO 3838 | 724-737 | 750-760 | 771-778 | 785-791 | 797-807 |
| [kg/m³] | | | | | | |
| Density (@20 °C) | ISO 3838 | 720-733 | 745-755 | 767-774 | 783-789 | 795-805 |
| [kg/m³] | | | | | | |
| Kinematic | ASTM D445 | 0.765-0.815 | 1.03-1.12 | 1.65-1.85 | 2.00-3.05 | 5.60-7.00 |
| viscosity | | | | | | |
| (@25 °C) [cSt] | | | | | | |
| Kinematic | ASTM D445 | 0.675-0.715 | 0.87-0.93 | 1.30-1.45 | 2.10-2.80 | 3.95-4.80 |
| viscosity | | | | | | |
| (@40 °C) [cSt] | | | | | | |
| Bromine number | ASTM | <1 | <1 | <1 | <1 | <1 |
| [g/100 g] | D1159 | | | | | |
| Aniline point [°C] | ASTM D611 | 66-72 | 70-76 | 78-85 | 85-92 | 95-100 |
| Aromatic content | GC/MS | <2000 | <2000 | <2000 | <2000 | <2000 |
| [ppm] | | | | | | |
| Composition: | | | | | | |
| n-paraffins | GC/MS | 15-22 | 17-27 | 25-36 | 28-40 | 34-60 |
| iso-paraffins | | 48-63 | 58-71 | 60-69 | 60-70 | 40-66 |
| cyclo-paraffins | | 17-35 | 9-22 | 2-7 | 0-5 | 0-5 |

*BP—Boiling point

TABLE 2-3
composition (wt %) of different solvent
fractions, feedstock PE/PP 30/70 + 5% PS

| | 100-150 | 150-190 | 190-240 | 240-280 | 280-320 |
|---|---|---|---|---|---|
| | °C | °C | °C | °C | °C |
| n-paraffins | 8-20 | 10-21 | 19-27 | 20-31 | 25-36 |
| iso-paraffins | 59-65 | 70-74 | 68-75 | 69-77 | 64-72 |
| cyclo-paraffins | 21-27 | 9-17 | 5-6 | 0-4 | 0-4 |
| aromatics | 0 | 0 | 0 | 0 | 0 |

TABLE 2-3
composition (wt %) of different solvent
fractions, feedstock PE/PP 70/30 + 5% PS

| | 100-150 | 150-190 | 190-240 | 240-280 | 280-320 |
|---|---|---|---|---|---|
| | °C | °C | °C | °C | °C |
| n-paraffins | 15-20 | 16-22 | 25-30 | 26-32 | 37-41 |
| iso-paraffins | 45-52 | 58-62 | 64-70 | 68-72 | 58-64 |
| cyclo-paraffins | 26-36 | 19-23 | 4-8 | 0-2 | 0 |
| aromatics | 0 | 0 | 0 | 0 | 0 |

TABLE 2-4
composition (wt %) of different solvent
fractions, feedstock PE/PP 70/30

| | 100-150 | 150-190 | 190-240 | 240-280 | 280-320 |
|---|---|---|---|---|---|
| | °C | °C | °C | °C | °C |
| n-paraffins | 18-22 | 24-28 | 32-38 | 36-42 | 55-62 |
| iso-paraffins | 60-64 | 60-66 | 60-65 | 58-63 | 38-45 |
| cyclo-paraffins | 16-20 | 8-12 | 0-5 | 0 | 0 |
| aromatics | 0 | 0 | 0 | 0 | 0 |

TABLE 2-5
analytical results for additional paraffinic solvents

| Parameter | Method | Solvent 6 | Solvent 7 | Solvent 8 | Solvent 9 |
|---|---|---|---|---|---|
| Distillation | | | | | |
| range [°C]: | | | | | |
| Initial BP* | ISO 3405 | 97-107 | 149-156 | 198-204 | 248-252 |
| 90% | | 145-148 | 190-193 | 237-242 | 300-310 |
| Final BP | | 165-180 | 200-215 | 250-265 | 315-325 |
| Flash point [°C] | ASTM D93 | <10 | >35 | >65 | >100 |
| Density (@15 °C) | ISO 3838 | 724-745 | 750-760 | 770-785 | 790-805 |
| [kg/m³] | | | | | |
| Density (@20 °C) | ISO 3838 | 720-740 | 745-755 | 770-779 | 785-800 |
| [kg/m³] | | | | | |
| Kinematic | ASTM D445 | 0.750-0.850 | 1.10-1.30 | 1.90-2.30 | 3.50-4.50 |
| viscosity | | | | | |
| (@25 °C) [cSt] | | | | | |
| Kinematic | ASTM D445 | 0.650-0.750 | 0.9-1.1 | 1.50-1.80 | 2.5-3.5 |
| viscosity | | | | | |
| (@40 °C) [cSt] | | | | | |
| Bromine number | ASTM | <0.5 | <0.5 | <0.5 | <0.5 |
| [g/100 g] | D1159 | | | | |
| Aniline point [°C] | ASTMD611 | 65-75 | 70-80 | 80-90 | 90-95 |
| Aromatic content | GC/MS | <2000 | <2000 | <2000 | <2000 |
| [ppm] | | | | | |
| Color (Saybolt) | ASTMD156 | +30 | +30 | +30 | +30 |
| Sulfur content | ISO 20846 | <1 | <1 | <1 | <1 |
| [mg/kg] | | | | | |
| Chloride content | PN EN 14077 | <1 | <1 | <1 | <1 |
| [mg/kg] | | | | | |
| Nitrogen content | ASTMD4629 | <1 | <1 | <1 | <1 |
| [mg/kg] | | | | | |
| Vapor pressure | PN EN | 6.0-8.5 | <3.0 | <1.5 | <1.0 |
| (37.8 °C) [kPa] | 13016-1 | | | | |
| Refractive index | PN81 / | 1.269-1.550 | 1.279-1.563 | 1.343-1.641 | 1.296-1.584 |
| | C04952 | | | | |

*BP—Boiling point

Table 3 provides analytical data for paraffinic oil products obtained by a process of this disclosure.

TABLE 3
analytical results for paraffinic oils, feedstock PE/PP, 5% PS

| Parameter | Method | Oil 1 | Oil 2 | Oil 3 |
|---|---|---|---|---|
| Appearance | Visual | Clear and | Clear and | Clear and |
| | | bright | bright | bright |
| Odor | Olfactory | Absent | Absent | Absent |
| Density (@15 °C) | ISO 3838 | 815-825 | 820-823 | 808-818 |
| [kg/m³] | | | | |
| Density (@20 °C) | ISO 3838 | 812-822 | 817-820 | 803-815 |
| [kg/m³] | | | | |
| Kinematic viscosity | ISO 3104 | 8.5-11.5 | 9.7-14.7 | 6.0-7.5 |
| (@40 °C) [cSt] | | | | |
| Kinematic viscosity | ISO 3104 | 2.0-3.1 | 2.7-3.5 | 2.0-2.5 |
| (@100 °C) [cSt] | | | | |
| Flash point [°C] | ASTM D93 | >145 | >140 | >140 |
| Pour point [°C] | ISO 3016 | <−20 | <−20 | <−20 |
| Cloud point [°C] | ISO 3015 | <−10 | <−20 | <−10 |
| Aniline point [°C] | ISO 2977 | >105 | >105 | >105 |
| Color (Saybolt) | ASTMD156 | +30 | | +30 |
| Sulfur | ISO 20846 | <1 | | <1 |
| content [mg/kg] | | | | |
| Nitrogen | ASTM D4629 | <3 | | <3 |
| content [mg/kg] | | | | |
| Distillation | | | | |
| range [°C]: | | | | |
| Initial BP* | SIMDIST, | 316 | | |
| Final BP | ASTM D7500 | 380 | | |
| Aromatic | GC/MS | 0 | 0 | 0 |
| content [ppm] | | | | |
| iso-paraffins | GC/MS | 100% | 100% | 100% |
| | | C14-C32 | C14-C32 | C14-C32 |

*BP—Boiling point

Tables 4-1 and 4-2 provides analytical data for paraffinic waxes obtained by a process of this disclosure.

TABLE 4-1
analytical results for paraffinic waxes, feedstock PE/PP

| Parameter | Method | Wax 1 | Wax 2 | Wax 3 | Wax 4 | Wax 5 |
|---|---|---|---|---|---|---|
| Color | Visual | White | White | White | White | White |
| Odor | Olfactory | Absent | Absent | Absent | Absent | Absent |
| Density (@15 °C) | ISO 3838 | 820-870 | 835-875 | 860-885 | 820-870 | 860-885 |
| [kg/m³] | | | | | | |
| Flash point [°C] | ASTM D93 | >175 | >200 | >180 | >160 | >175 |
| Needle penetration | ASTM D1321 | >100 | 75-100 | 65-90 | >100 | 61-78 |
| (@25 °C) [0.1 mm] | | | | | | |
| Congealling point | ASTM D938 | 45-55 | 56-62 | 67-75 | 45-55 | 67-75 |
| [°C] | | | | | | |
| Kinematic viscosity | ISO 3104 | 3.5-5.2 | 5.0-7.0 | 8.0-9.5 | 3.5-4.6 | 8.0-9.5 |
| (@100 °C) [cSt] | | | | | | |
| Oil content [% m/m] | ASTM D721 | 30-40 | 19-27 | 10-18 | 30-40 | 9-16 |
| Aromatic content | GC/MS | <2000 | <2000 | <2000 | <2000 | <2000 |
| [ppm] | | | | | | |
| n-paraffins | GC/MS | ~98% C20- | ~98% C20- | ~98% C20- | ~98% C20- | ~98% C20- |
| | | C70 | C70 | C70 | C70 | C70 |

TABLE 4-2
analytical results for paraffinic
waxes, feedstock PE/PP + 5 wt % PS

| Parameter | Method | Wax 6 | Wax 7 | Wax 8 |
|---|---|---|---|---|
| Color | Visual | White | White | White |
| Odor | Olfactory | Absent | Absent | Absent |
| Density (@15 °C) | ISO 3838 | 820-870 | 835-875 | 860-885 |
| [kg/m³] | | | | |
| Flash point [°C] | ASTM D93 | >180 | >240 | >260 |
| Needle penetration | ASTM D1321 | >100 | 75-100 | 65-90 |
| (@25 °C) [0.1 mm] | | | | |
| Congealling | ASTM D938 | 45-55 | 55-65 | 60-75 |
| point [°C] | | | | |
| Kinematic viscosity | ISO 3104 | 3.5-5.2 | 5.0-7.0 | 8.0-9.5 |
| (@100 °C) [cSt] | | | | |
| Oil content [% m/m] | ASTM D721 | 30-50 | 19-35 | 10-20 |
| Aromatic content | GC/MS | <2000 | <2000 | <2000 |
| [ppm] | | | | |
| n-paraffins | GC/MS | ~98% | ~98% | ~98% |
| | | C20-C70 | C20-C70 | C20-C70 |
| n-paraffins | ASTM D5442 | 24.09% | 34.55% | 33.68% |
| | | C20-C70 | C20-C70 | C20-C70 |

Table 5 provides analytical data for a solid product, i.e. dried reactor bottoms, obtained by a process of this disclosure.

TABLE 5
analytical results for solid product

| Parameter | Method | Solid 1 |
|---|---|---|
| Appearance | Visual | Black solid |
| Density (@15 °C) [kg/m³] | PN-EN ISO 3838 | 1273 |
| Sulfur content [wt %] | PN EN 15408: 2011 | 0.06 |
| Nitrogen content [wt %] | PN-G-04571: 1998 | 0.06 |
| Chlorine content [wt %] | PN-EN 15408: 2011 | 0.17 |
| Hydrogen content [wt %] | PN-G-04571: 1998 | 8.82 |
| Ash [wt %] | TGA | 9.85 |
| Carbon [wt %] | PN-G-04571: 1998 | 59.10 |
| Volatile matter [wt %] | PN-G-04516: 1998 | 86.20 |
| Calorific value [MJ/kg] | Calorimeter | 41.40 |
| Mercury content [ppm] | ASA | 0.005 |
| Total moisture [wt %] | TGA | 0.80 |

1-49. (canceled)

50. A process for obtaining paraffinic products having an aromatic compounds content of at most about 3000 ppm from a mixture of polyolefins, the process comprising:
(a) thermocracking said mixture in a melt state in a thermolysis reactor to obtain a hydrocarbons vapor stream under conditions comprising (i) pressure of at most 1 barg, (ii) temperature ranging between about 320 °C and about 450 °C, (iii) absence of oxygen, and (iv) residence time of the mixture in the thermolysis reactor of between 2 and 40 hours;
(b) removing volatile C1-C5 compounds from the hydrocarbons vapor stream and quenching the remainder of the hydrocarbons vapor stream to obtain a condensate stream;
(c) transferring the condensate stream into a main catalytic hydrotreatment unit, to obtain a hydrotreated stream;
(d) separating the hydrotreated stream into product streams:
(i) a C6-C20 product stream having a boiling temperature of between about 60 °C and about 330 °C,
(ii) a C14-C32 product stream having a boiling temperature of between about 300 °C and about 450 °C, and
(iii) a C20-C70 product stream having a boiling temperature of at least about 350 °C; and
(e) further treating each of the product streams to obtain paraffinic products, the paraffinic products comprising:
(i) a C6-C20 paraffinic product having an aromatic compounds content of at most about 3000 ppm,
(ii) a C14-C32 paraffinic product having an aromatic compounds content of at most about 3000 ppm, and
(iii) a C20-C70 paraffinic product having an aromatic compounds content of at most about 3000 ppm.

51. The process of claim 50, wherein the C6-C20 paraffinic product, the C14-C32 paraffinic product, and/or the C20-C70 paraffinic product have an aromatic compounds content of at most about 2000 ppm.

52. The process of claim 50, wherein each of the C6-C20 paraffinic product, the C14-C32 paraffinic product, or the C20-C70 paraffinic product has an aromatic compounds content of at most about 2000 ppm.

53. The process of claim 50, wherein the thermolysis reactor comprises a heated circulation loop defined between a circulation outlet and a circulation inlet, for circulating a portion of the mixture therethrough during thermocracking.

54. The process of claim 53, wherein the temperature in the circulation loop is between about 400 °C and about 450 °C, and/or wherein said potion of mixture within the circulation loop during thermocracking is between about 2% and about 50% of the thermolysis reactor's volume.

55. The process of claim 50, wherein step (a) further comprises removal of solid residues from the thermolysis reactor.

56. The process of claim 50, wherein the main catalytic hydrotreatment unit is operated at step (c) is carried out under conditions comprising:
temperature of between about 250 °C and about 340 °C,
pressure of at least 45 barg, and
a hydrogen to condensate stream ratio of at least 150 Nm³/m³.

57. The process of claim 56, wherein the difference between inlet temperature of the second stream to the main catalytic hydrotreatment unit and the temperature in the main catalytic hydrotreatment unit is at most 50 °C.

58. The process of claim 50, wherein step (e) comprises treating each of the product streams as follows:
(i) catalytically hydrotreating said C6-C20 product stream, followed by distillation in at least one solvent distillation column to obtain said C6-C20 paraffinic product having an aromatic compounds content of at most about 3000 ppm,
(ii) catalytically hydrotreating said C14-C32 product stream, followed by distillation in at least one oil distillation column to obtain said C14-C32 paraffinic product having an aromatic compounds content of at most about 3000 ppm, and
(iii) distilling said C20-C70 product stream in at least one wax distillation column to obtain said C20-C70 paraffinic product having an aromatic compounds content of at most about 3000 ppm.

59. The process of claim 58, wherein catalytically hydrotreating said C6-C20 product stream in step (e) is carried out under conditions comprising:
temperature of between about 170 °C and about 300 °C,
pressure of at least 45 barg, and
a hydrogen to condensate stream ratio of at least 150 Nm³/m³.

60. The process of claim 59, wherein catalytically hydrotreating said C14-C32 product stream in step (e) is carried out under conditions comprising a temperature of between about 310 °C and about 360 °C, pressure of at least 25 barg, and a hydrogen to C14-C32 product stream ratio of at least 150 Nm³/m³.

61. The process of claim 59, wherein catalytically hydrotreating said C14-C32 product stream in step (e) is carried out in two consecutive hydrotreatment steps:
step (e1) comprising hydrotreating the C16-C32 product stream under conditions comprising a temperature of between about 310 °C and about 360 °C, pressure of at least 25 barg, and a hydrogen to C14-C32 product stream ratio of at least 150 Nm³/m³; followed by
step (e2) comprising hydrotreating the product of step (e1) under conditions comprising a temperature of between about 170 °C and about 300 °C, pressure of at least 25 barg, and a hydrogen to C14-C32 product stream ratio of at least 150 Nm³/m³.

62. The process of claim 50, wherein the condensate stream of step (b) is passed through at least one guard bed reactor comprising at least one guard bed catalyst prior to introduction into step (c).

63. The process of claim 62, wherein the temperature in the at least one guard bed reactor is between about 290 °C and about 340 °C, and/or wherein the hydrogen to condensate stream ratio in the at least one guard bed reactor is about 150 Nm³/m³.

64. The process of claim 50, wherein said mixture of polyolefins comprise polyethylene and polypropylene.

65. The process of claim 64, wherein the mixture comprises polyethylene in an amount ranging between 10 wt % and 90 wt %, and polypropylene polyethylene in an amount ranging between 10 wt % and 90 wt %.

66. The process of claim 64, wherein the mixture consists substantially of polyethylenes or polypropylenes.

67. The process of claim 50, wherein said mixture comprises up-to 10 wt % of polystyrene, and/or up-to 5 wt % of non-polyolefinic polymers other than polystyrene.

68. A process for recycling polyolefins waste, comprising:
(a) thermocracking said polyolefins waste in a melt state in a thermolysis reactor to obtain a hydrocarbons vapor stream under conditions comprising (i) pressure of at most 1 barg, (ii) temperature ranging between about 320 °C and about 450 °C, (iii) absence of oxygen, and (iv) residence time of the mixture in the thermolysis reactor of between 2 and 40 hours;
(b) removing volatile C1-C5 compounds from the hydrocarbons vapor stream and quenching the remainder of the hydrocarbons vapor stream to obtain a condensate stream;
(c) transferring the condensate stream into a main catalytic hydrotreatment unit, to obtain a hydrotreated stream;
(d) separating the hydrotreated stream into product streams:
(i) a C6-C20 product stream having a boiling temperature of between about 60 °C and about 330 °C,
(ii) a C14-C32 product stream having a boiling temperature of between about 300 °C and about 450 °C, and
(iii) a C20-C70 product stream having a boiling temperature of at least about 350 °C; and
(e) further treating each of the product streams to obtain said paraffinic products, the paraffinic products comprising:
(i) a C6-C20 paraffinic product having an aromatic compounds content of at most about 3000 ppm,
(ii) a C14-C32 paraffinic product having an aromatic compounds content of at most about 3000 ppm, and
(iii) a C20-C70 paraffinic product having an aromatic compounds content of at most about 3000 ppm.

69. The process of claim 68, wherein said further treating at step (e) comprises:
(i) catalytically hydrotreating said C6-C20 product stream, followed by distillation in at least one solvent distillation column to obtain said C6-C20 paraffinic product having an aromatic compounds content of at most about 3000 ppm,
(ii) catalytically hydrotreating said C14-C32 product stream, followed by distillation in at least one oil distillation column to obtain said C14-C32 paraffinic product having an aromatic compounds content of at most about 3000 ppm, and
(iii) distilling said C20-C70 product stream in at least one wax distillation column to obtain said C20-C70 paraffinic product having an aromatic compounds content of at most about 3000 ppm.
